(19) United States
(12) Patent Application Publication
(10) Pub. No.: US 2007/0242709 A1
(43) Pub. Date: Oct. 18, 2007

(54) Laser pulse fault detection method and system

(76) Inventors: Shan Chong Tan, (US); Ping Seng Lee, (US); Wooi Kip Lim, (US); Vincent Wen Yuan Ong, (US)

Correspondence Address: Kathy Manke;Avago Technologies Limited, 4380 Ziegler Road, Fort Collins, CO, 80525, US

(21) Appl. No.: 11/406,032

(22) Filed: Apr. 18, 2006

(51) Int. Cl. H01S 3/13

(52) U.S. Cl. 372/30

(57) ABSTRACT

An optical navigation system for driving a laser device with a laser pulse fault detection employs a controller, a laser driver and a laser pulse fault detector. In operation, the controller provides the laser pulse train signal to the laser driver and the laser pulse fault detector. In response thereto, and the laser pulse fault detector enable a driving of the laser device by the laser driver based on detection of a normal timing condition of the laser pulse train and overrides a driving of the laser device by the laser driver based on a detection of an abnormal timing condition of the laser pulse train signal.

### FIELD OF THE INVENTION

The present invention relates to optical navigation systems. The present invention specifically relates to detecting abnormal lengths of time an on-chip laser driver is turned on.

### BACKGROUND OF THE INVENTION

Power saving is getting increased attention in cordless optical mouse sensors in recent years. In order to maintain the performance while achieving better battery life performance, a pulsing method has typically been utilized in the design of cordless optical mouse sensors. Specifically, a snapshot of a movement of a cordless optical mouse sensor is recorded in a periodic manner. To the end, a short pulse of laser power is emitted from a laser in each movement frame as controlled by an optical navigation system.

For example, FIG. 1 illustrates a known optical navigation system 30 employing a digital controller 40 and a laser driver 50 whereby, in operation, digital controller 40 applies a laser enable signal LES to a laser power supply 20. In response to laser enable signal LES, laser power supply 20 applies a voltage component of a laser power signal LPS to a laser device 21 (e.g., a vertical cavity semiconductor emitting laser). During the enabling of laser power supply 20, digital controller 40 also applies a laser pulse train LPT to laser driver 50, which in response thereto draws a current component of a laser drive signal LDS from laser power supply 20 through laser device 21 causing a current component of laser power signal LPS to flow through laser device 21 in accordance with a frequency and a duty cycle of laser pulse train LPT.

A drawback to laser pulse train LPT is a potential for an eye-safety hazard to an end-user of the optical mouse. Currently, as illustrated in FIG. 2, this potential for an eye-safety hazard is minimized by a laser power and on-time control of laser driver 50 involving a pulsing of laser device 21 at a duty cycle of normal pulse time NPT/frame time FT with a laser power level LPL (e.g. 1000 uW) that is higher than an eye-safety level ESL (e.g. 716 uW). Nonetheless, an average laser power level APL (e.g., 500 uW) is lower the eye-safety level ESL as long as the pulsing of laser device 21 remains at the PT/FT duty cycle (e.g., 25% IS THIS A GOOD EXAMPLE).

Under an abnormal timing condition with laser pulse train LPT of FIG. 1, (e.g., clock for laser pulse train LPT ceases after laser device 21 is powered on), a control of laser driver 50 will be unable to turn off laser device 21 at the end of normal pulse time NPT whereby the laser power of laser device 21 will remain at laser power level LPL for an abnormal pulse time APT as illustrated in FIG. 3. Accordingly, there is a need for a laser pulse fault detection for turning off laser device 21 under any abnormal condition of laser pulse train LPT.

### SUMMARY OF THE INVENTION

The present invention provides a new and unique laser pulse fault detection for implementation in optical navigation systems.

One form of the present invention is an optical navigation system for driving a laser device with a laser pulse fault detection. The optical navigation system comprises a controller operable to provide the laser pulse train signal, a laser driver operably coupled to the controller to drive the laser device based on the laser pulse train signal, and a laser pulse fault detector operably coupled to the controller to enable a driving of the laser device by the laser driver based on detection of a normal timing condition of the laser pulse train and to override a driving of the laser device by the laser driver based on a detection of an abnormal timing condition of the laser pulse train signal.

A second form of the present invention is an optical navigation system for driving a laser device with a laser pulse fault detection. The optical navigation system comprises a controller operable to provide the laser pulse train signal, a laser driver operably coupled to the controller to drive the laser device based on the laser pulse train signal, and a laser pulse fault detector operably coupled to the controller, wherein the laser pulse fault detector include means for enabling a driving of the laser device by the laser driver based on detection of a normal timing condition of the laser pulse train, and means for overriding a driving of the laser device by the laser driver based on a detection of an abnormal timing condition of the laser pulse train signal.

A third form of the present invention is a method of laser pulse fault detection of a pulsing of a laser device based on a laser pulse train. The method comprises an enabling of a driving of the laser device based on detection of a normal timing condition of the laser pulse train, wherein the normal timing condition of the laser pulse train is defined as each pulse of the laser pulse train having an actual pulse time that is less than a default pulse time established for safety purposes, and an overriding of a driving of the laser device based on a detection of an abnormal timing condition of the laser pulse train, wherein the abnormal timing condition of the laser pulse train is defined as a pulse of the laser pulse train having an actual pulse time that equals or exceeds the default pulse time.

The aforementioned forms and additional forms as wells as objects and advantages of the present invention will become further apparent from the following detailed description of the various embodiments of the present invention read in conjunction with the accompanying drawings. The detailed description and drawings are merely illustrative of the present invention rather than limiting, the scope of the present invention being defined by the appended claims and equivalents thereto.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 illustrates a block diagram of an optical navigation system as known in the art;

FIG. 2 illustrates a normal timing condition of a laser pulse train generated by the optical navigation system illustrated in FIG. 1 as known in the art;

FIG. 3 illustrates an abnormal timing condition of a laser pulse train generated by the optical navigation system illustrated in FIG. 1 as known in the art;

FIG. 4 illustrates a no-fault detection of a normal timing condition of a laser pulse train in accordance with the present invention;

FIG. 5 illustrates a fault detection of an abnormal timing condition of a laser pulse train in accordance with the present invention;

FIG. 6 illustrates a block diagram of one embodiment of an optical navigation system in accordance with the present invention;

FIG. 7 illustrates a flowchart representative of one embodiment of a laser pulse train detection method in accordance with the present invention;

FIG. 8 illustrates an exemplary operation of the optical navigation system illustrated in FIG. 6 in accordance with the flowchart illustrated in FIG. 7;

FIG. 9 illustrates an exemplary embodiment of the optical navigation system illustrated in FIG. 6 in accordance with the present invention;

FIG. 10 illustrates a flowchart representative of an exemplary embodiment of the laser pulse fault detection method illustrated in FIG. 7 in accordance with the present invention; and

FIG. 11 illustrates an exemplary operation of the optical navigation system illustrated in FIG. 9 in accordance with the flowchart illustrated in FIG. 10.

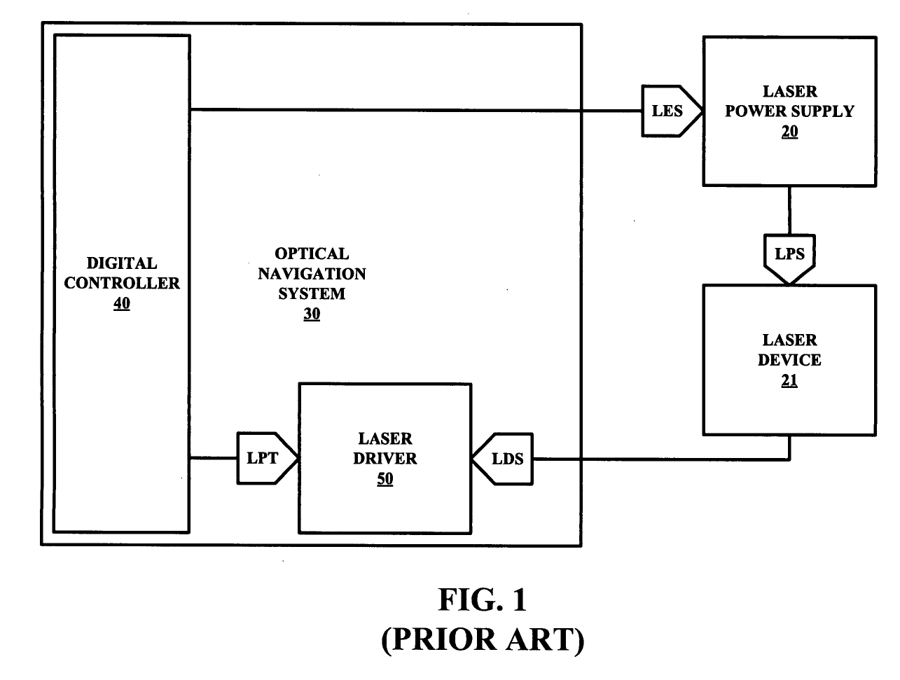

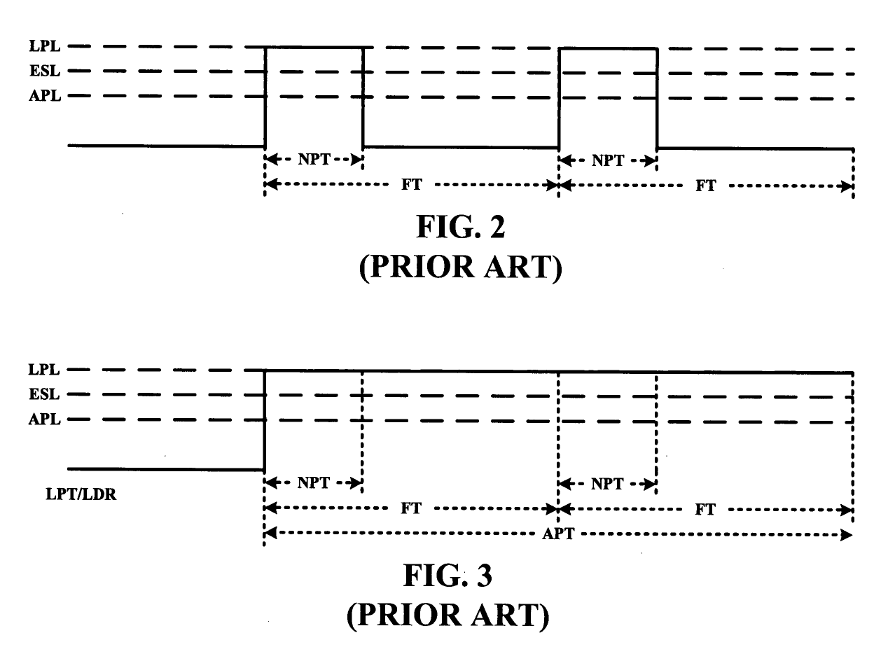

### DETAILED DESCRIPTION OF THE INVENTION

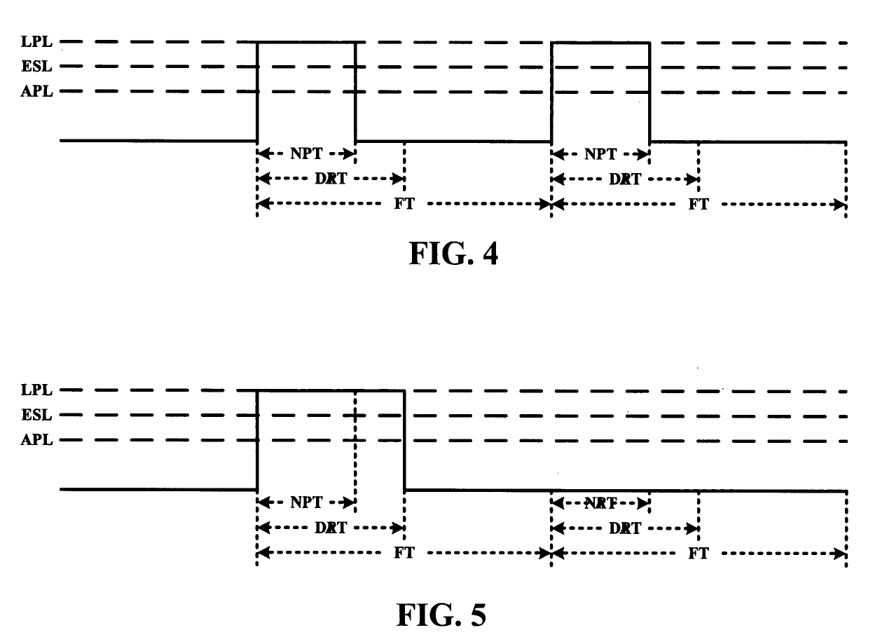

The present invention is premised on an introduction of a default pulse time within the framework of a pulsing of a laser device to provide a constant default monitoring of a time the laser device is turned on to thereby ensure an eye-safety of a user of an optical navigation system. Specifically, as illustrated in FIGS. 4 and 5, a default pulse time DPT is introduced within the framework of a pulsing of a laser device to establish a normal timing condition and an abnormal timing condition. The normal timing condition is defined as an actual pulse time of a each pulse of the laser device being less than a default pulse time DPT (e.g., the actual pulse time of each pulse matching the normal pulse time NPT as shown in FIG. 4) to thereby ensure a continued safe pulsing of the laser device. Conversely, an abnormal timing condition is defined as the actual pulse time of any pulse of the laser device equaling or exceeding default pulse time DPT as shown in FIG. 5 to thereby discontinue the pulsing of the laser device for safety reasons.

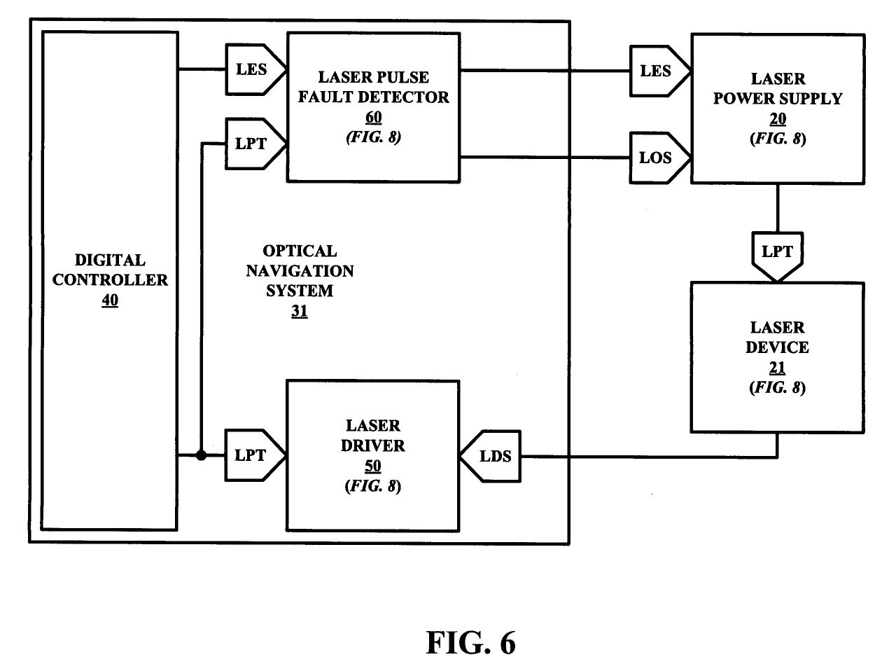

To this end, as illustrated in FIG. 6, the present invention provides an optical navigation system 31 employing a laser pulse fault detector 60 in addition to digital controller 40 and laser device 50. Generally, in operation, digital controller 40 applies a laser enable signal LES to laser power supply 20 via laser pulse fault detector 60. In response to laser enable signal LES as previously described herein, laser power supply 20 applies a voltage component of a laser power signal LPS to laser device 21. During the enabling of laser power supply 20, digital controller 40 also applies a laser pulse train LPT to both laser driver 50 and laser fault detector 60.

In response to laser pulse train LPT, as previously described herein, laser driver 50 draws a current component of laser drive signal LDS from laser power supply 20 through laser device 21 causing a current component of laser power signal LPS to flow through laser device 21 in accordance with a frequency and a duty cycle of laser pulse train LPT. Concurrently, laser pulse fault detector 60 monitors laser pulse train LPT whereby laser pulse fault detector 60 will continue to apply laser enable signal LES to laser power supply 20 in response to detecting a normal condition of laser pulse train LPT and will alternatively apply a laser override signal LOS to laser power supply 20 in response to detecting an abnormal pulse condition of laser pulse train LPT. Laser override signal LOS disables laser power supply 20 to thereby cease a driving of laser device 21 by laser driver 50 in view of the abnormal condition of laser pulse train LPT.

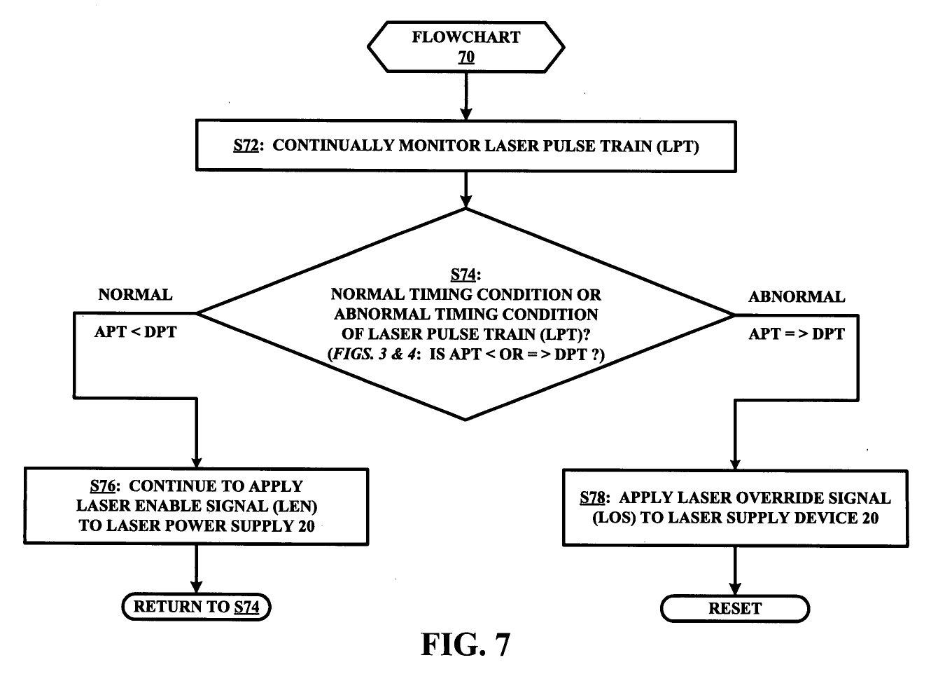

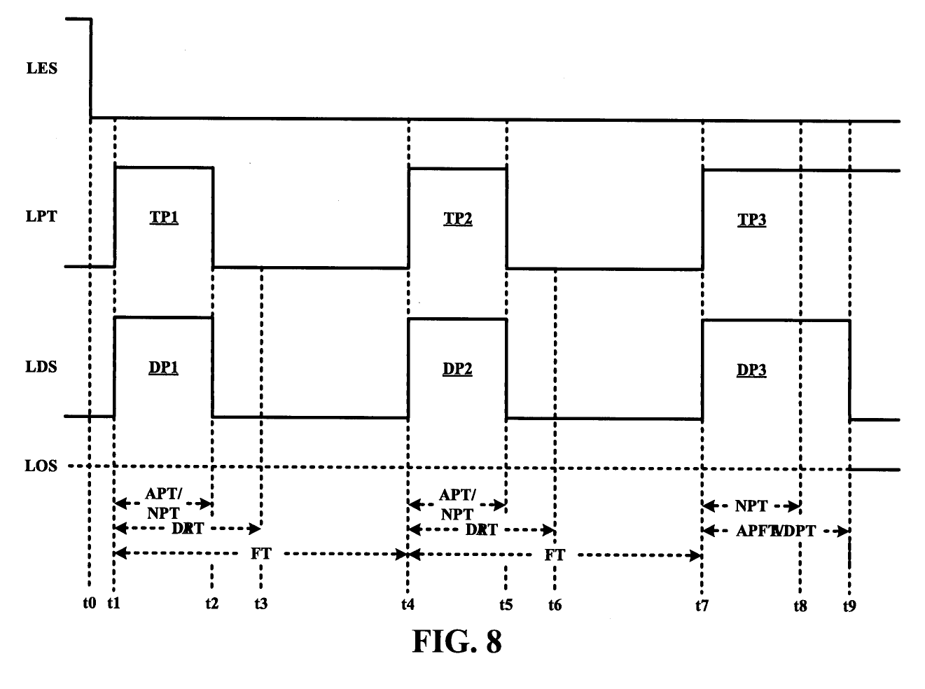

In one embodiment, laser pulse fault detector 60 implements a laser pulse fault detection method of the present invention as represented by a flowchart 70 illustrated in FIG. 7. To facilitate an understanding of an implementation of the laser pulse fault detection method of the present invention by laser pulse fault detector 60, an execution of flowchart 70 will be described in connection with an exemplary description of the various signals associated with a pulsing of laser device 21 subsequent to an application of laser enable signal LES by laser pulse fault detector 60 to laser power supply 20 at a time t0 as shown in FIG. 8.

Specifically, a stage S72 of flowchart 70 encompasses laser pulse fault detector 60 continually monitoring laser pulse train LPT and a stage S74 of flowchart 70 encompasses laser pulse fault detector 60 determining whether laser pulse train LPT is pulsing under a normal pulse condition or an abnormal pulse condition.

As shown in FIG. 8, a train pulse TP1 of laser pulse train LPT has an actual pulse time APT equal to a normal pulse time NPT of t2−t1, which is less than a default pulse time DPT of t3−t1. As a result, a stage S76 of flowchart 70 encompasses laser pulse fault detector 60 continuing to apply laser enable signal LES to laser power supply 20 whereby a drive pulse DP1 of laser drive signal LDS matching a frequency and a duty cycle of train pulse TP1 draws a current component of laser power signal LPS through laser device 21 during the normal pulse time of t2−t1.

As shown in FIG. 8, a train pulse TP2 of laser pulse train LPT has an actual pulse time APT equal to a normal pulse time NPT of t5−t4, which is less than a default pulse time DPT of t6−t4. As a result, stage S76 of flowchart 70 encompasses laser pulse fault detector 60 continuing to apply laser enable signal LES to laser power supply 20 whereby a drive pulse DP2 of laser drive signal LDS matching a frequency and a duty cycle of train pulse TP2 draws a current component of laser power signal LPS through laser device 21 during the normal pulse time of t5−t4.

As shown in FIG. 8, a train pulse TP3 of laser pulse train LPT has an actual pulse time APT exceeding a normal pulse time NPT of t8−t7 and reaching a default pulse time DPT of t9−t7. As a result, a stage S78 of flowchart 70 encompasses laser pulse fault detector 60 applying laser override signal LOS to laser power supply 20 at time t9 whereby a drive pulse DP3 of laser drive signal LDS safely draws a current component of laser power signal LPS through laser device 21 during the default pulse time t9−t7. Subsequent to time t9, laser pulse fault detector 60 either automatically resets itself or awaits a resetting by digital controller 40 whereby, in either case, the application of laser override signal LOS by laser pulse fault detector 60 to laser power supply 20 is terminated to facilitate a future pulsing of laser device 21 in accordance with the present invention.

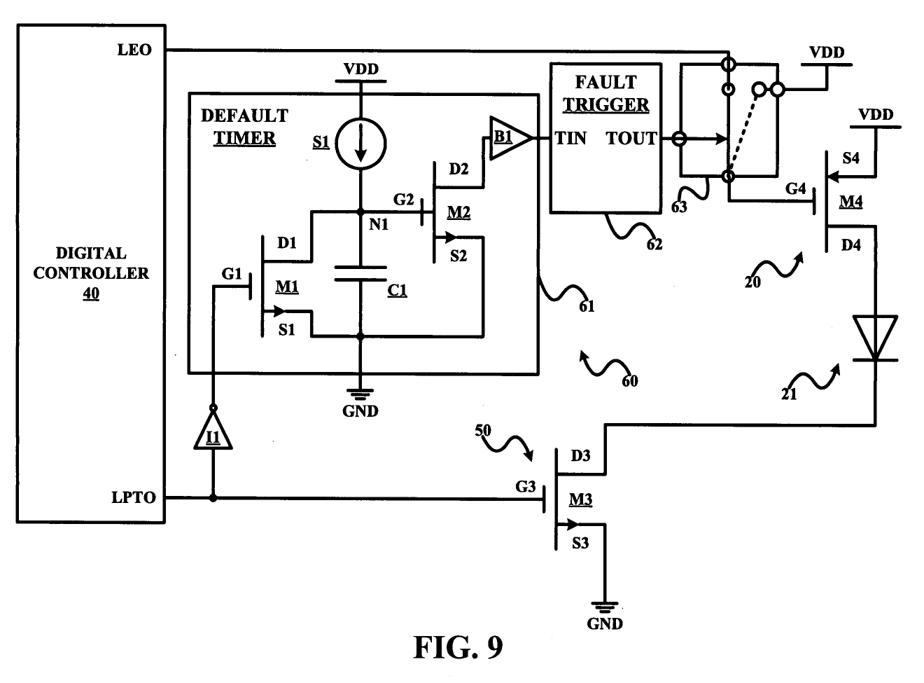

FIG. 9 illustrates an exemplary embodiment of FIG. 6. Specifically, laser power supply 20 employs a P-channel MOSFET M4 having a source terminal S4 electrically connected to a power supply VDD and a drain terminal D4 electrically connected to an anode terminal of a vertical cavity semiconductor emitting laser (“VCSEL”) 21. Laser driver 50 employs a N-channel MOSFET M3 having a gate terminal G3 electrically connected to a laser pulse train output LPTO of digital controller 40, a drain terminal D3 electrically connected to a cathode terminal of VCSEL 21, and a source terminal S3 electrically connected to ground GND.

Laser pulse fault detector 60 employs a default timer 61, a fault trigger 62 and an override switch 63. Default trigger 61 employs a constant current source S1, a N-channel MOSFET M1, a capacitor C1, a N-channel MOSFET M2, and a buffer B1. Constant current source S1 is electrically connected between a power supply VDD and a constant current node N1. N-channel MOSFET M1 has a gate terminal G1 electrically connected to a laser pulse train output LPTO of digital controller 40 via an inverter I1, a drain terminal D1 electrically connected to constant current node N1, and a source terminal S3 electrically connected to ground GND. Capacitor C1 is electrically connected between constant current node N1 and ground GND. N-channel MOSFET M2 has a gate terminal G2 electrically connected to constant current node N1, a drain terminal D1 electrically connected to an input of buffer B1, and a source terminal S2 electrically connected to ground GND. An output of buffer B1 is electrically connected to an trigger input TIN of fault trigger 62.

A trigger output TOUT of fault trigger 62 is electrically connected to a control input of override switch 63. In an open state, override switch 63 electrically connects a laser enable output LEO of digital controller 40 to a gate G4 of P-channel MOSFET M4. In a closed state, override switch 63 electrically connects power supply VDD to gate G4 of P-channel MOSFET M4.

Generally, in operation, override switch 63 is initially set in a closed state whereby laser enable signal LES can be applied by digital controller to gate G4 of P-channel MOSFET M4 to thereby facilitate a pulsing of VCSEL 21 under a normal pulse condition of laser pulse train LPT. Default timer 61 monitors each pulse of the laser pulse train to detect any abnormal pulse condition of laser pulse train LPT. If an abnormal pulse condition is detected by default timer 61, fault trigger 62 is activated to trigger an opening of override switch 63 to thereby turn off P-channel MOSFET M4 irrespective of laser enable signal LES.

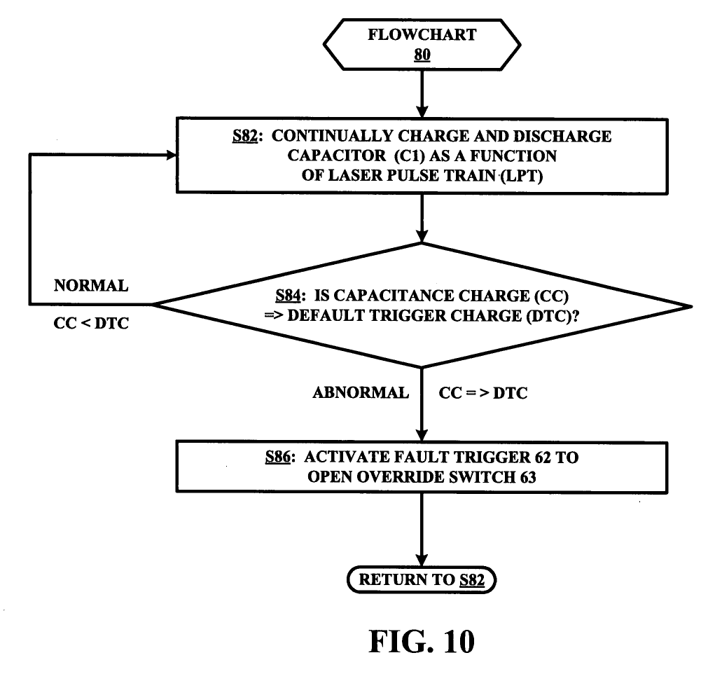

In one embodiment, default timer 61 implements a laser pulse fault detection method of the present invention as represented by a flowchart 80 illustrated in FIG. 10. To facilitate an understanding of an implementation of the laser pulse fault detection method of the present invention by default timer 61, an execution of flowchart 80 will be described in connection with an exemplary description of the various signals associated with a pulsing of VCSEL 21 subsequent to an application of laser enable signal LES by laser pulse fault detector 60 to laser power supply 20 at a time to as shown in FIG. 10.

Specifically, a stage S82 of flowchart 80 encompasses laser pulse fault detector 60 charging capacitor C1 in response to a logic high level of laser pulse train LPT (i.e., a pulse) turning off N-channel MOSFET M1, and conversely, discharging capacitor C1 in response to a logic low level of laser pulse train LPT turning on N-channel MOSFET M1. A stage S84 of flowchart 80 encompasses laser pulse fault detector 60 determining whether a capacitance charge CC of capacitor C1 is less than a default charge DC to thereby define a normal pulse condition of laser pulse train LPT or conversely equal to or greater than the default trigger charge DTC to thereby define an abnormal pulse condition of laser pulse train LPT. To this end, a charging rate of capacitor C1 is designed to facilitate capacitance charge CC equaling default trigger charge DTC upon an expiration of default pulse time DPT. More particularly, the charging rate of capacitor C1 is equal to I_{S}/C where I_{S} is current supplied by constant current source S1 and C is the capacitance of capacitor C1. As such, default trigger charge DTC is equal to DPT*(I_{S}/C) and is used as a trigger level for fault trigger 62.

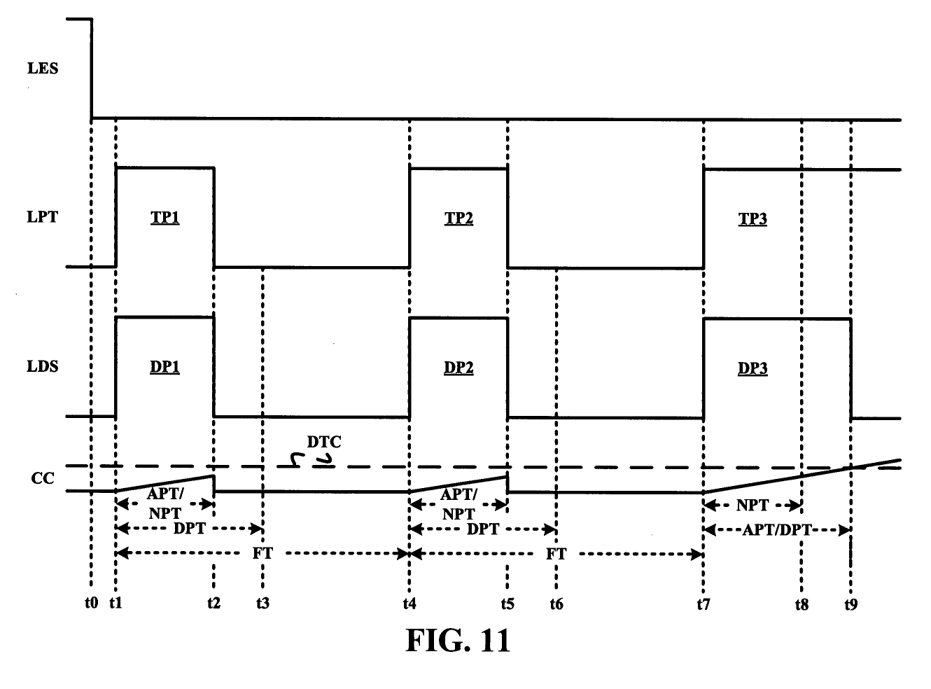

As shown in FIG. 11, a train pulse TP1 of laser pulse train LPT has an actual pulse time APT equal to a normal pulse time NPT of t2−t1, which is less than a default pulse time DPT of t3−t1. As a result, a stage S84 of flowchart 80 encompasses default timer 61 charging capacitor C1 with a capacitance charge CC that is less the default trigger charge DTC at the expiration the actual pulse time APT at time t2 whereby a drive pulse DP1 of laser drive signal LDS matching a frequency and a duty cycle of train pulse TP1 draws a current component of laser power signal LPS through laser device 21 during the normal pulse time of t2−t1.

As shown in FIG. 11, a train pulse TP2 of laser pulse train LPT has an actual pulse time APT equal to a normal pulse time NPT of t5−t4, which is less than a default pulse time DPT of t6−t4. As a result, stage S84 of flowchart 80 encompasses default timer 61 charging capacitor C1 with a capacitance charge CC that is less the default trigger charge DTC at the expiration the actual pulse time APT at time t5 whereby a drive pulse DP2 of laser drive signal LDS matching a frequency and a duty cycle of train pulse TP2 draws a current component of laser power signal LPS through laser device 21 during the normal pulse time of t5−t4.

As shown in FIG. 11, a train pulse TP3 has an actual pulse time APT exceeding a normal pulse time NPT of t8−t7 and reaching a default pulse time DPT of t9−t7. As a result, stage S84 of flowchart 80 encompasses default timer 61 charging capacitor C1 with a capacitance charge CC that equals default trigger charge DTC at the expiration the default pulse time DPT at time t9 to thereby trigger an opening of override switch 63 by fault trigger 62 during a stage S86 of flowchart 80 whereby laser override signal LOS is applied to gate G4 of P-channel MOSFET M4. Consequently, drive pulse DP3 of laser drive signal LDS safely draws a current component of laser power signal LPS through laser device 21 during the default pulse time t9−t7. Subsequent to time t9, override switch 62 is automatically reset to the closed state based on a discharging of the capacitance charge CC of capacitor C1 below default trigger charge DTC or is reset to the closed state by digital controller 40 whereby, in either case, the application of laser override signal LOS to laser power supply 20 is terminated to facilitate a future pulsing of laser device 21 in accordance with the present invention.

Referring to FIG. 9, those having ordinary skill in the art will appreciate how to apply the inventive principles of the present invention to any type of optical navigation systems, particularly optical navigation systems have a more highly structured configuration that the optical navigation system illustrated in FIG. 9.

Referring to FIGS. 7 and 10, those having ordinary skill in the art will appreciate how to implement flowcharts 70 and 80 irrespective as to whether digital controller 40 is or is not enabling laser power supply 20 via laser pulse fault detector 60.

Referring to FIGS. 4-11, those having ordinary skill in the art will further appreciate numerous advantages and benefits of the present invention, including, but not limited to, a constant default monitoring of a time a laser device is turned on by an optical navigation system to thereby ensure eye safety of a user of the optical navigation system.

While the embodiments of the invention disclosed herein are presently considered to be preferred, various changes and modifications can be made without departing from the scope of the invention. The scope of the invention is indicated in the appended claims and all changes that come within the meaning and range of equivalents are intended to be embraced therein.

What is claimed is:

1. An optical navigation system for driving a laser device with a laser pulse fault detection, the optical navigation system comprising:
a controller operable to provide the laser pulse train signal;
a laser driver operably coupled to the controller to drive the laser device based on the laser pulse train signal; and
a laser pulse fault detector operably coupled to the controller to enable a driving of the laser device by the laser driver based on detection of a normal timing condition of the laser pulse train and to override a driving of the laser device by the laser driver based on a detection of an abnormal timing condition of the laser pulse train signal.

2. The optical navigation system of claim 1, wherein the controller is a digital controller operable to provide the laser pulse train signal having a specified duty cycle and a specified power level to facilitate an average laser power of the laser power train signal that is below an eye-safety limit.

3. The optical navigation system of claim 1, wherein the normal timing condition of the laser pulse train is defined as each pulse of the laser pulse train having an actual pulse time that is less than a default pulse time established by the laser pulse fault detector.

4. The optical navigation system of claim 1,
wherein the controller is further operable to provide a laser enable signal; and
wherein the laser pulse fault detector includes an override switch operable to apply the laser enable signal to a laser power supply based on the normal timing condition of the laser pulse train.

5. The optical navigation system of claim 1, wherein the abnormal timing condition of the laser pulse train is defined as a pulse of the laser pulse train having an actual pulse time that equals or exceeds a default pulse time established by the laser pulse fault detector.

6. The optical navigation system of claim 1,
wherein the controller is further operable to provide a laser enable signal; and
wherein the laser pulse fault detector includes an override switch operable to override the laser enable signal by apply a laser override signal to a laser power supply based on the abnormal timing condition of the laser pulse train.

7. The optical navigation system of claim 3, wherein the laser pulse fault detector includes a default timer operable to charge and discharge an electric charge storage as a function of the laser pulse train.

8. The optical navigation system of claim 7, wherein the normal timing condition of the laser pulse train is a function of a capacitance charge of the electric storage device being less than a default trigger charge.

9. The optical navigation system of claim 7, wherein the abnormal timing condition of the laser pulse train is a function of a capacitance charge of the electric storage device being equal to or greater than a default trigger charge.

10. The optical navigation system of claim 7, wherein the laser pulse fault detector further includes an override switch operable in a closed state to apply a laser enable signal to a laser power supply based on a capacitance charge of the electric storage device being less than a default trigger charge and operable in an open sate to apply a laser override signal to the laser power supply based on the capacitance charge of the electric storage device being equal to or greater than the default trigger charge.

11. The optical navigation system of claim 10, wherein the laser pulse fault detector further includes a fault trigger operable to switch the override switch from the closed state to the open state in response to the capacitance charge of the electric storage device equaling the default trigger charge.

12. An optical navigation system for driving a laser device with a laser pulse fault detection, the optical navigation system comprising:
a controller operable to provide the laser pulse train signal;
a laser driver operably coupled to the controller to drive the laser device based on the laser pulse train signal; and
a laser pulse fault detector operably coupled to the controller, wherein the laser pulse fault detector includes:
means for enabling a driving of the laser device by the laser driver based on detection of a normal timing condition of the laser pulse train, and
means for overriding a driving of the laser device by the laser driver based on a detection of an abnormal timing condition of the laser pulse train signal.

13. A method of laser pulse fault detection of a pulsing of a laser device based on a laser pulse train, the method comprising:
enabling a driving of the laser device based on detection of a normal timing condition of the laser pulse train, wherein the normal timing condition of the laser pulse train is defined as each pulse of the laser pulse train having an actual pulse time that is less than a default pulse time established for safety purposes; and
overriding a driving of the laser device based on a detection of an abnormal timing condition of the laser pulse train, wherein the abnormal timing condition of the laser pulse train is defined as a pulse of the laser pulse train having an actual pulse time that equals or exceeds the default pulse time.

14. The method of claim 13, wherein the enabling of the driving of the laser device based on the detection of the normal timing condition of the laser pulse train includes:
applying a laser enable signal to a laser power supply to facilitate a powering of the laser device.

15. The method of claim 13, wherein the enabling of the driving of the laser device based on the detection of the normal timing condition of the laser pulse train includes:
a charging and discharging an electric charge storage as a function of the laser pulse train, wherein the normal timing condition of the laser pulse train is a function of a capacitance charge of the electric storage device being less than a default trigger charge.

16. The method of claim 13, wherein the overriding of the driving of the laser device based on the detection of the abnormal timing condition of the laser pulse train includes:
applying a laser override signal to a laser power supply to cease a powering of the laser device.

17. The method of claim 13, the overriding of the driving of the laser device based on the detection of the abnormal timing condition of the laser pulse train includes:
a charging and discharging an electric charge storage as a function of the laser pulse train, wherein the abnormal timing condition of the laser pulse train is a function of a capacitance charge of the electric storage device being equal to or greater than a default trigger charge.

18. The method of claim 17, wherein the default pulse time is a function of a rate of charge of the electric charge storage.
